(19) United States
(12) Patent Application Publication
(10) Pub. No.: US 2024/0308370 A1
(43) Pub. Date: Sep. 19, 2024

(54) TIRE PRESSURE CHARGING SYSTEM

(71) Applicant: Arnold Chase, West Hartford, CT (US)

(72) Inventor: Arnold Chase, West Hartford, CT (US)

(21) Appl. No.: 18/316,601

(22) Filed: May 12, 2023

Related U.S. Application Data
(63) Continuation of application No. 18/185,773, filed on Mar. 17, 2023.

(51) Int. Cl. B60L 53/38; B60L 53/12; B60L 53/65; H02J 50/10; H02J 50/80; H02J 50/90

(52) U.S. Cl. CPC B60L 53/38; B60L 53/12; B60L 53/65; H02J 50/10; H02J 50/80; H02J 50/90

(57) ABSTRACT

A system for charging a vehicle having a receiving coil and an electric power source electrically coupled to the receiving coil includes a charging coil, at least one tire positioning sensor, and a controller operably coupled to the at least one tire positioning sensor and the charging coil. The controller is operable to determine a location of the receiving coil and adjust a position of the charging coil in response to the location of the receiving coil to maximize a charge rate of the electric power source.

### CROSS-REFERENCE TO RELATED APPLICATIONS

This application is a Continuation of U.S. application Ser. No. 18/185,773, filed Mar. 17, 2023, the contents of which are incorporated by reference herein in their entirety.

### FIELD

Embodiments of the present disclosure relate to vehicle charging systems and, more particularly, wireless vehicle charging systems for electric vehicles.

### BACKGROUND

Conventionally, the operator of an electric vehicle intentionally decides not only at what point in the vehicle's discharge cycle to invoke a recharging sequence, but also at what particular location the vehicle recharging will take place.

In order to wirelessly recharge the battery or power-pack of an electric vehicle, a vehicle operator would need to purposefully decide to drive to a specific location that was equipped with a wireless electric vehicle charger and manually effectuate a charging cycle. Typically, in an effort to prolong the time between recharging sessions, an electric vehicle is operated until its battery pack is substantially or almost completely depleted, at which point the battery-pack would ordinarily be recharged in its entirety within one continuous charging session. This approach is not only time-consuming, but also typically requires purposeful travel to a charging station location while the vehicle is immobile for long periods of time. Inherently, this operation protocol also leaves an electric vehicle with a partial charge state much of the time.

In addition, as wireless vehicle charging becomes increasingly used not only with different types of vehicles, but also within different categories or types of vehicles, the variance in vehicular dimensions and configurations inherently creates problems when trying to align the charging coil of a ground assembly with a receiving coil of a vehicle.

### SUMMARY

According to an embodiment, a system for charging a vehicle having a receiving coil and an electric power source electrically coupled to the receiving coil includes a charging coil, at least one tire positioning sensor, and a controller operably coupled to the at least one tire positioning sensor and the charging coil. The controller is operable to determine a location of the receiving coil and adjust a position of the charging coil in response to the location of the receiving coil to maximize a charge rate of the electric power source.

In addition to one or more of the features described above, or as an alternative, in further embodiments the controller is operable to receive vehicle-specific information from the vehicle.

In addition to one or more of the features described above, or as an alternative, in further embodiments the vehicle-specific information includes a year, make, and model of the vehicle.

In addition to one or more of the features described above, or as an alternative, in further embodiments the vehicle-specific information includes a vehicle identification number.

In addition to one or more of the features described above, or as an alternative, in further embodiments the controller is operable to identify at least one physical dimension of the vehicle in response to the vehicle-specific information.

In addition to one or more of the features described above, or as an alternative, in further embodiments the at least one tire positioning sensor is operable to sense a location of a footprint of a tire of the vehicle.

In addition to one or more of the features described above, or as an alternative, in further embodiments the at least one tire positioning sensor includes an array of mechanical action switches.

In addition to one or more of the features described above, or as an alternative, in further embodiments the at least one tire positioning sensor includes a pressure sensor mat.

In addition to one or more of the features described above, or as an alternative, in further embodiments the controller is operable to receive a signal indicating an overall position of the vehicle from the at least one tire positioning sensor. The controller is operable to determine the location of the receiving coil in response to the signal indicating the position of the vehicle.

In addition to one or more of the features described above, or as an alternative, in further embodiments the location of the receiving coil determined by the controller includes a distance of the receiving coil above a ground level.

In addition to one or more of the features described above, or as an alternative, in further embodiments including a positioning system operably coupled to the charging coil and to the controller.

In addition to one or more of the features described above, or as an alternative, in further embodiments the controller is operable to communicate at least one of the location of the receiving coil and a movement command to the positioning system.

According to an embodiment, a system for charging a vehicle having a receiving coil and an electric power source electrically coupled to the receiving coil includes a charging coil, a positioning system operably coupled to the charging coil, at least one tire positioning sensor, and a controller operably coupled to the at least one tire positioning sensor, the charging coil, and the positioning system. The controller is operable to receive a signal indicating a position of a tire of the vehicle relative to the at least one tire positioning sensor, receive vehicle-specific information, identify an exact location of the receiving coil based on the position of the tire of the vehicle relative to the at least one tire positioning sensor and the vehicle-specific information, and communicate the exact location of the receiving coil to the positioning system.

In addition to one or more of the features described above, or as an alternative, in further embodiments being operable to receive the signal indicating the position of the tire includes being operable to receive the signal indicating the position of a first tire and a second tire of the vehicle relative to the at least one tire positioning sensor.

In addition to one or more of the features described above, or as an alternative, in further embodiments, the controller includes an RFID reader operable to receive the vehicle-specific information from the vehicle.

In addition to one or more of the features described above, or as an alternative, in further embodiments, the controller is operable to identify at least one physical dimension of the vehicle using the vehicle-specific information.

In addition to one or more of the features described above, or as an alternative, in further embodiments the controller is operable to identify the position of the receiving coil relative to the tire using the at least one physical dimension of the vehicle.

In addition to one or more of the features described above, or as an alternative, in further embodiments the vehicle-specific information includes a year, make, and model of the vehicle.

In addition to one or more of the features described above, or as an alternative, in further embodiments the vehicle-specific information includes a vehicle identification number.

### BRIEF DESCRIPTION OF THE DRAWINGS

The following descriptions should not be considered limiting in any way. With reference to the accompanying drawings, like elements are numbered alike:

FIG. 1 is a schematic diagram of a tire related charging system for charging an electric vehicle is illustrated according to an embodiment;

FIG. 2 is a schematic diagram of a portion of the tire related charging system of FIG. 1 according to an embodiment;

FIG. 3 is a plan view of a tire positioning sensor of a tire related charging system according to an embodiment;

FIG. 4 is a cross-sectional view of a tire positioning sensor of a tire related charging system according to an embodiment;

FIG. 5 is a schematic diagram of the portion of the tire related charging system having an electric vehicle parked thereon at the perfect approach angle according to an embodiment;

FIG. 6 is a schematic diagram of the portion of the tire related charging system having an electric vehicle parked thereon at an imperfect approach angle according to an embodiment;

FIG. 7 is a detailed view of the skewed centerline of the electric vehicle relative to the perfect approach centerline according to an embodiment;

FIG. 8 is an end view of a vehicle having a marker positioned for reading by a scanning device according to an embodiment;

FIG. 9 is a method of operating a tire related charging system to position a charging induction coil and a receiving induction coil in an optimized charging position.

### DETAILED DESCRIPTION

Although various features have been shown in different figures for simplicity, it should be readily apparent to one of skill in the art that the various features may be combined without departing from the scope of the present disclosure. A charging system as described herein supplies charging coil positional guidance to a wireless charging system's logic input to provide a simple and effective means for harmonizing a ground charging or transmitting coil and a vehicle charging coil. Apart from automatically determining the year, make, and model of an electric vehicle that is wireless charging capable, the charging system is operable to determine the physical juxtaposition of a wireless charging system's transmitting coils relative to vehicle's receiving coil.

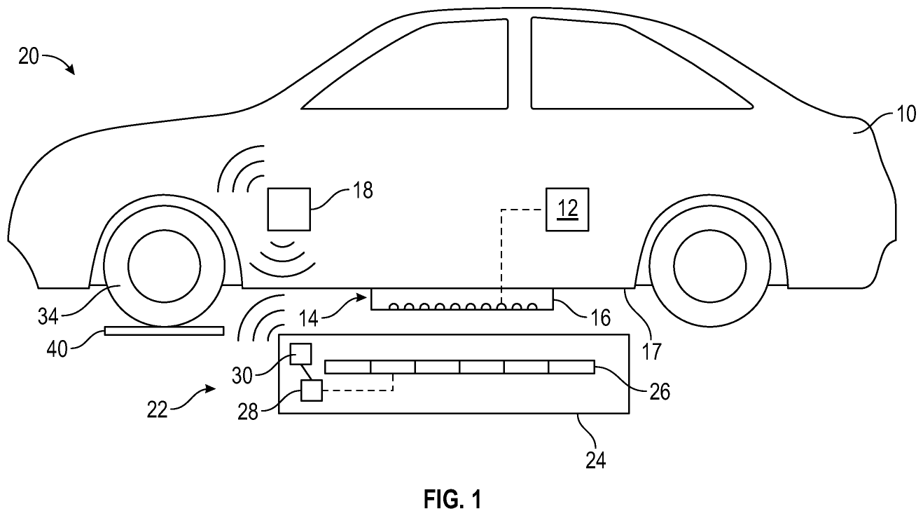

With reference now to FIG. 1, an example of a tire related charging system (TRCS) 20 for charging or supplying power to an electric power source 12, such as a battery pack for example, of an electric vehicle 10 is illustrated. It should be appreciated that a vehicle as described herein may be a manually driven vehicle, or alternatively or in addition, may be driven autonomously. As shown, the TRCS 20 includes a ground assembly 22 including a charging unit 24 having at least one charging induction coil 26 (also referred to herein as a charging coil) arranged therein. A system controller 28 may be operably connected to the charging unit 24, and in some embodiments to the charging induction coil 26. In an embodiment, the controller 28 is also operably connected to a transceiver 30. The transceiver 30 may but need not include a separate transmitter and receiver. As shown, the electric vehicle 10 has a receiving assembly 14 including at least one receiving induction coil 16 (also referred to herein as a receiving coil) operably coupled to the electric power source 12. The receiving induction coil 16 may be arranged at or adjacent to a bottom side 17 of the electric vehicle 10, facing toward the charging induction coil 26 when the electric vehicle 10 is generally positioned over the ground assembly 22. In an embodiment, the electric vehicle 10 includes a transceiver 18 which may be configured to communicate with the transceiver 30 of the TRCS 20.

To charge the electric power source 12 of the electric vehicle 10, the electric vehicle 10 is parked relative to the TRCS 20 such that the receiving induction coil 16 integrated into the electric vehicle 10 is positioned above the charging induction coil 26. The charging induction coil 26 generates a charging current or energy within the receiving induction coil 16 which can be transferred to the battery or electric power source 12 of the electric vehicle 10, such as via a power cable (not shown) for example.

The energy transfer between the charging induction coil 26 and the receiving induction coil 16 is maximized when the receiving induction coil 16 is substantially aligned with the charging induction coil 26 in the longitudinal, lateral, and vertical directions within a predetermined threshold. However, when an electric vehicle 10 is parked by an operator relative to the tire related charging system 20, the position of the receiving induction coil 16 may vary relative to the initial position of the charging induction coil 26. For example, the receiving induction coil 16 may be laterally or longitudinally offset from the charging induction coil 26. Alternatively, or in addition, a central longitudinal axis of the receiving induction coil 16 may be arranged at a non-parallel angle relative to a central longitudinal axis of the charging induction coil 26.

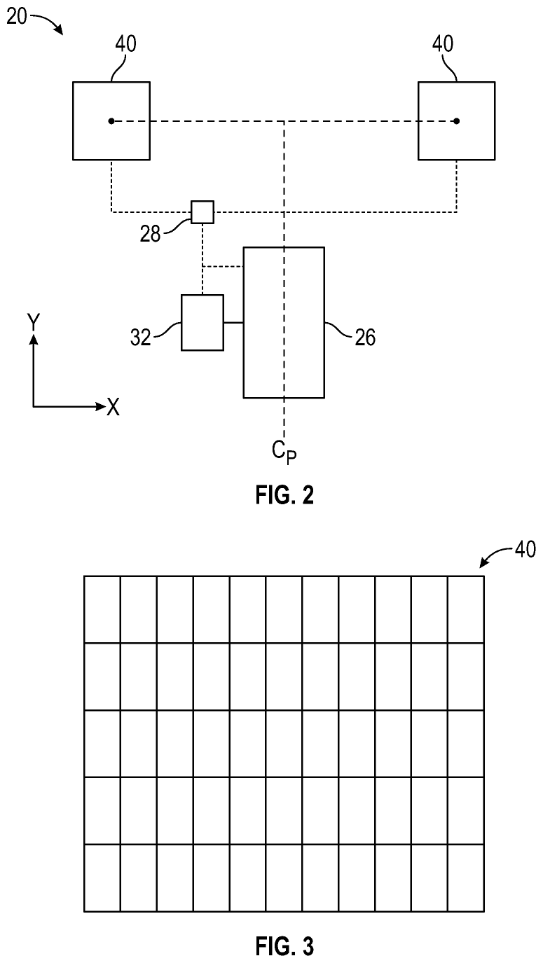

To optimize the energy transfer between the charging induction coil 26 and the receiving or transmitting induction coil 16 and therefore maximize a charge rate of the electric power source 12, the relative positioning of the charging induction coil 26 and the transmitting induction coil 16 may be controlled. With reference to FIG. 2, in an embodiment, the TRCS 20 includes a positioning system 32 for adjusting a position of the ground assembly 22, and more particularly the position of the charging induction coil 26. For example, the positioning system 32 may include one or more motors (not shown) for driving movement of the charging induction coil 26 along an X. Y, and/or Z axis. However, it should be appreciated that a positioning system 32 having any suitable configuration is within the scope of the disclosure.

To control the relative position of the charging induction coil 26 and the receiving induction coil 16, such as by providing positional guidance to the positioning system 32 associated with the charging induction coil 26 for example, the TRCS 20 must know the position of both the charging induction coil 26 and the receiving induction coil 16. Different types of electric vehicles 10 may have a receiving induction coil 16 arranged at various locations relative to the chassis or tires of the electric vehicle 10. To adapt the TRCS 20 for use with different types of electric vehicles 10, the electric vehicle 10 may be configured to communicate or transmit vehicle-specific information to the controller 28. The data content of this transmission from the electric vehicle 10 to the controller 28 could contain vehicle and/or specific locational charging system characteristics which are individualized and specific to the vehicle desiring a charge from the TRCS 20. In an embodiment, at a minimum, the data transmitted from the electric vehicle 10 to the controller 28 before a charging session commences may include the Vehicle Identification Number (VIN). The VIN inherently contains configuration information about the electric vehicle that is requesting a charge, including the year, country, and factory of manufacture; the make and model; and the serial number of the vehicle.

The controller 28 may either maintain an on-board memory or may be able access an on-line database of the relevant dimensional information associated with various vehicle makes and models for each year. Using the information from the VIN to access at least one physical dimension of an electric vehicle 10 and its components, a controller 28 can easily resolve an X-Y mounting position of the receiving induction coil 16 of the electric vehicle 10 based on the position and angle of a single tire, or the location of a pair of tires 34 of the electric vehicle 10, such as the front tires vehicle for example. The controller 28 can also determine a vertical offset between the receiving induction coil 16 of the electric vehicle 10 and a ground level. Further, by having the electric vehicle 10 communicate directly with the controller 28, the TRCS 20 may seamlessly, dynamically, and automatically reconfigure various electrical and/or physical parameters to provide compatibility between the TRCS 20 and an electric vehicle 10.

Just as various makes and models of internal combustion vehicles may be ordered and equipped with different engine choices (with each engine choice having differing physical requirement characteristics such as different engine oil capacities), electric vehicles (EV) are already offered with various voltage and/or capacity power packs. It should be appreciated that in the future different other options may also be available from vehicle manufacturers that could impact the charging process. Further to the transmitted VIN, additional vehicle-specific information such as this may be appended to the transmitted VIN essentially creating a “VIN+” which may include, but not be limited to, information as to the size and voltage(s) of the installed battery pack(s), the target amount and maximum instantaneous charging current allowed for the specific vehicle/battery pack configuration, the “not to exceed” total charging current amounts per a given time-frame, the maximum charging acceptance rate that the vehicle can safely handle during a charging cycle, the maximum charging voltage the vehicle can accept, etc. In an embodiment, the vehicle-specific information transmitted with the VIN includes the physical characteristics or dimensions of a vehicle 10 and may in some embodiments include the position of a receiving induction coil 16 relative to the vehicle.

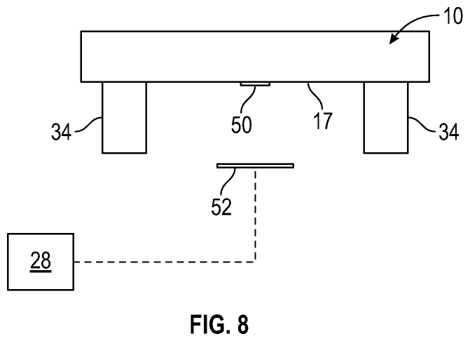

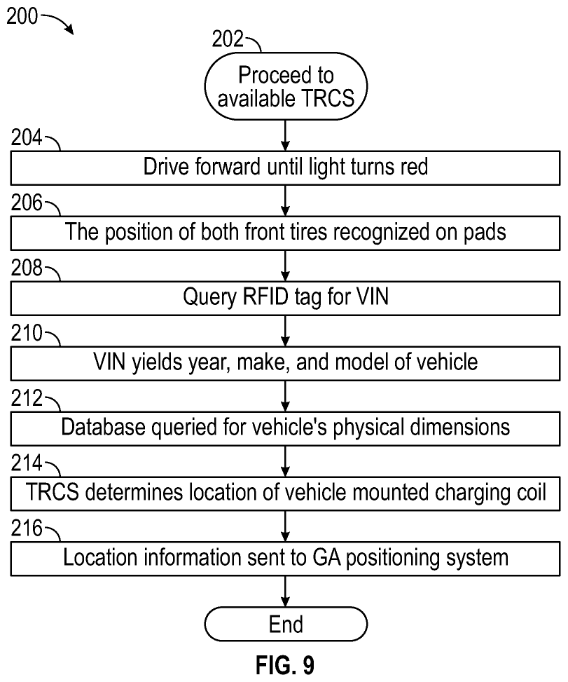

In an embodiment, this communication of the vehicle-specific information may occur via radio frequency identification (RFID). For example, the electric vehicle 10 may have an RFID tag or other transponding device that is programmed to respond when prompted with a vehicle's VIN. The RFID tag may be affixed at any suitable location about the electric vehicle 10, such as at an underside 17 thereof for example, and the TRCS 20 may include a corresponding RFID reader operable to communicate with and read the information stored on the RFID tag of the electric vehicle 10. It should be appreciated that communication via RFID as described herein is intended as an example only. In other embodiments, the vehicle-specific information may be communicated to the TRCS 20 via short range radio protocols, such as Bluetooth(T), or Near Field Communication for example. It should be appreciated that in an embodiment, the vehicle-specific information provided to the TRCS 20 may also be used to effectuate billing in a secure manner. With reference to FIG. 8, in another embodiment, a marker, such as a barcode or QR code for example, represented schematically at 50, is affixed to a portion of the vehicle 10. In the illustrated, non-limiting embodiment, the marker 50 is arranged at the underside 17 of the vehicle, however, embodiments where the marker is arranged at another location are also contemplated herein. . . . In such embodiments, the TRCS 20 may include a scanning device, such as a laser for example, represented schematically at 52, for reading the marker 50 affixed to the vehicle 10. The scanning device 52 may be positioned such that as the vehicle 10 approaches a final charging position relative to the TRCS 20, the vehicle 10, and specifically the marker 50, reaches a position where the marker 50 is readable by the scanning device 52. As shown, in embodiments where the marker 50 is arranged at an underside 17 of the vehicle 10, the scanning 52 device may be arranged at a location over which the vehicle 10 is configured to drive. In an embodiment, the marker 50 provides the VIN such that the controller 28 of the TRCS 20 can access or retrieve the relevant dimensional information associated with the vehicle 10 as previously described. However, in other embodiments, the marker 50 may directly provide the relevant dimensional information including the location of the charging induction coil 26.

Alternatively, or in addition, the TRCS 20 may include one or more sensors operable to monitor one or more parameters of the electric vehicle 10, such as physical characteristics of the electric vehicle for example. Using the sensed parameters of the electric vehicle, the TRCS 20 may be able to identify a year, make, and model of the vehicle, and then determine a mounting position of the receiving induction coil 16 as previously described. However, in other embodiments, the one or more sensors may be operable to monitor one or more parameters associated with the mounting position of the receiving induction coil 16 relative to the electric vehicle 10.

The TRCS 20 may additionally include at least one sensor 40 for identifying the exact location of the electric vehicle 10 in an X-Y plane oriented generally parallel to the ground, and in some embodiments, the exact location of the receiving induction coil 16 of the electric vehicle 10, not only in the X-Y plane, but also in a perpendicular Z-direction. In the illustrated non-limiting embodiment, the at least one sensor 40 is operable to determine a positional configuration of one or more tires 34 of the electric vehicle 10. The at least one sensor 40 may be referred to herein as a “tire positioning sensor” and may but need not be stationary relative to the ground. The one or more tire positioning sensors 40 are operable to determine an X-Y position of the electric vehicle 10. Alternatively, or in addition, the one or more tire positioning sensors 40 are operable to determine an angular heading or skew of the electric vehicle 10. To identify the exact X-Y position and/or the skew of the electric vehicle 10, the at least one tire positioning sensor 40 may be operable to detect the position of a single tire, two tires, three tires, four tires, or more than four tires of the electric vehicle 10. Further, the at least one tire positioning sensor 40 is configured to communicate information regarding the position and/or skew of the electric vehicle 10 to the controller 28. As will be described in more detail below, by recognizing the footprint/impression of a merely a single tire, or alternatively, of multiple tires, the TRCS 20 is able to resolve the overall physical stance and orientation or skew of the vehicle.

With continued reference to FIG. 2, as shown, the first and second tire positioning sensors 40 may be substantially identical in size and shape and are physically separated from one another by a clearance. It should be appreciated that one or more of the size of the tire positioning sensors 40, the aspect ratio of the tire positioning sensors 40, and the spacing between the tire positioning sensors 40 may vary based on the type of electric vehicle 10 being used with the TRCS 20. In the illustrated, non-limiting embodiment, the first and second tire positioning sensors 40 are axially aligned about an X axis such that each tire positioning sensor 40 is configured to receive a front tire, or alternatively, each tire positioning sensor 40 is configured to receive a rear tire of an electric vehicle 10. However, in other embodiments, the first and second tire positioning sensors 40 may be axially aligned about a Y-axis, oriented substantially perpendicular to the X axis, such that one of the tire positioning sensors 40 is configured to receive a front tire and the other of the tire positioning sensors 40 is configured to receive a rear tire of the electric vehicle 10.

Although the TRCS 20 is illustrated as having a first tire positioning sensor and a second tire positioning sensor it should be appreciated that embodiments having a single tire positioning sensor 40, or alternatively, more than two tire positioning sensors, such as three or four tire positioning sensors, or embodiments having a tire positioning sensor associated with each tire of the electric vehicle 10 for example, are also within the scope of the disclosure. In embodiments including a single tire positioning sensor 40, the tire positioning sensor may be elongated such that two tires 34 of the electric vehicle 10 are simultaneously receivable in overlapping arrangement with the tire positioning sensor 40.

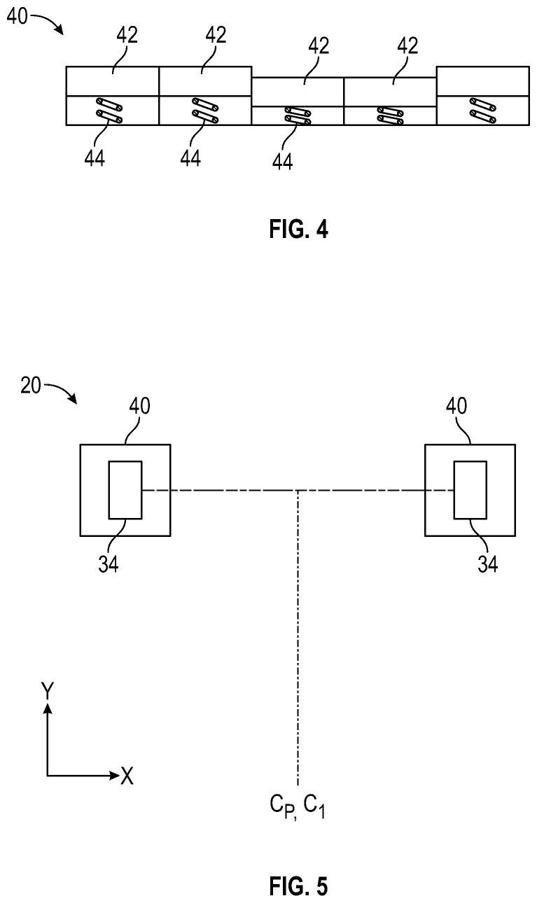

With reference now to FIG. 3, an example of a tire positioning sensor is illustrated. As shown, the tire positioning sensor 40 may include a pressure sensor mat, or another device suitable to identify a footprint or location and the orientation of at least one tire 34 relative thereto. As is known, a pressure sensor mat or a thin film pressure sensor is used to monitor dynamic pressure over an area by measuring the interface pressure between two contacting surfaces. In another embodiment, best shown in FIG. 4, the tire positioning sensor 40 includes an array of action switches 42 that are movable in response to engagement with a tire 34 to determine the position of the tire 34 relative to the tire positioning sensor 40. The action switches 42 may be plunger-type switches or other mechanical switches that are transformable between an extended position and a depressed or retracted position.

Each action switch 42 is in the extended position when a tire 34 is not arranged in contact therewith. In the extended position, a signal output from the action switch 42 to the controller 28 indicates that the action switch is in an “off” state. Each action switch 42 is in the depressed position when a tire 34 is engaged therewith or positioned thereon. In the depressed position, the action switch 42 generates a signal indicating to the controller 28 that the action switch is in an “on” or actuated state. Discrete individual wires (not shown) may be used to convey a status signal from each action switch 42 to the controller 28; however, in other embodiments, more efficient connection methods, such as matrices or sequential multiplexing, may also be used to communicate signals between the action switches 42 and the controller 28.

Depending on the various sensing requirements of the TRCS 20, the total number of action switches 42 within the array as well as the size and spacing between these action switches 42 may vary over a wide range of values. In an embodiment, different configurations of the array of action switches 42 could be used for different vehicular classifications based on the tire size associated with each vehicular classification. For example, a tire positioning sensor 40 operable to detect a standard size tire typically used with a compact passenger vehicle may have a first number of action switches 42, each having a first size or surface area engageable by a tire 34. Similarly, a tire positioning sensor 40 intended for use with a vehicle having oversized tires, such as a construction vehicle or a tractor trailer for example, may have a second reduced number of action switches 42, each having a second size or surface area engageable by a tire 34 and that is larger than the first surface area. By varying one or more parameters of the action switches 42 within the array, including but not limited to the total number of action switches 42, the surface area thereof engageable by a tire 34, or the spacing between adjacent action switches 42, the tire positioning sensors 40 associated with different vehicular classifications may have the same resolution or sensing granularity, or alternatively, may have different resolutions.

In an embodiment, the tire positioning sensor 40 is sealed and has a weathertight configuration. This weathertight configuration may be achieved via inclusion of a weatherproof layer. The weatherproof layer may be a common layer, coating, or boot extending over each of the plurality of action switches 42 within the array. Alternatively, each individual action switch 42 may have a weatherproofing layer or boot incorporated therein.

In an embodiment, at least one biasing mechanism 44 is associated with the array of action switches 42. As shown, a respective biasing mechanism 44 may be associated with each of the action switches 42 within the array, or alternatively, a single biasing mechanism 44 may be associated with multiple action switches 42 within the array. When a force exceeding the biasing force of the biasing mechanism 44, such as the weight of a tire for example, is applied to an action switch 42, the action switch 42 will move from the extended position to the retracted position. Upon movement of the force from the action switch 42 of tire positioning sensor 40, the biasing force of the biasing mechanism 44 will return to the action switch 42 to the normal or extended position.

The biasing force of the biasing mechanism 44 may be selected to maintain the action switch 42 in the extended, inactive position when a weight applied thereto is less than a predetermined threshold. In an embodiment, the predetermined threshold for actuating an action switch 42 is greater than an average weight of a person. For example, the biasing force of the biasing mechanism 44 may be sufficient to maintain an action switch 42 in the extended position when the weight of a person, such as a person standing on the tire positioning sensor 40, is applied to the action switch 42. In an embodiment, the predetermined threshold may be selected based on a type of vehicle intended to be charged at the TRCS 20.

When a tire 34 is parked on the tire positioning sensor 40, the weight or tread of the tire is configured to operate at least one, and in some embodiments a plurality of action switches 42 associated with the tire 34, such as the action switches 42 located directly underneath the tire 34 for example. Accordingly, the action switches 42 associated with the tire 34 are transformed from the extended position to the depressed position in response to engagement with the tire 34.

The controller 28 is configured to the evaluate the signals output from array of action switches 42 or from the pressure sensing matrix of the tire positioning sensor 40 to determine the position of the tire 34 relative to the tire positioning sensor 40. In an embodiment, the controller 28 is operable to determine an overall position of the vehicle based on the positional information of a single tire. In embodiments where two separate tire positioning sensors 40 are used, the signals output from each tire positioning sensor 40 identify a position of a corresponding tire 34 relative to the tire positioning sensor 40. In embodiments including a single tire positioning sensor 40, the signals generated may identify the position of both a first tire and a second tire, respectively.

Regardless of the type of tire positioning sensor(s) 40 being used, the distance extending between a respective center point of the first and second tire positioning sensors 40 may be stored within or accessed by the controller 28, or alternatively, may be sensed by another sensor of the TRCS 20 and communicated to the controller 28. In the illustrated, non-limiting embodiment of FIG. 2, the controller 28 is operable to identify a line C_{P} extending perpendicularly from a virtual axis connecting the center points of the two tire positioning sensors 40, the line C_{P} being located generally centrally between the two center points of the tire positioning sensors 40. This centerline C_{P} represents a “perfect” approach angle of an electric vehicle 10 relative to the TRCS 20, and in some embodiments relative to the tire positioning sensors 40.

In an embodiment, the position of the one or more tire positioning sensors 40 relative to the charging induction coil 26 is known by the controller 28. Accordingly, the controller 28 is therefore able to identify the position of the centerline C_{P} relative to the charging induction coil 26. In an embodiment, the centerline C_{P} is coaxial with a central longitudinal axis of the charging induction coil 26. However, embodiments where the centerline C_{P} is offset from or arranged at an angle relative to the central longitudinal axis of the charging induction coil 26 are also contemplated herein.

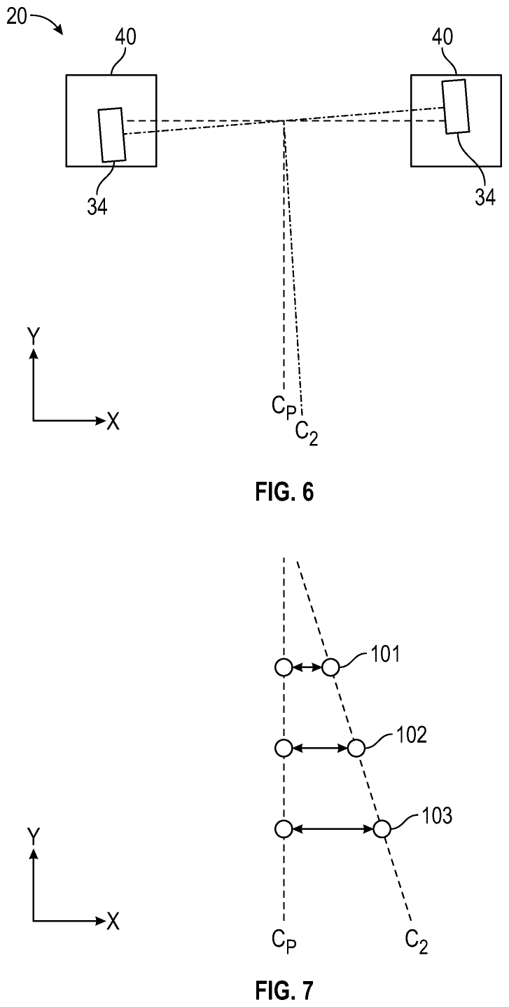

With reference to FIG. 5, the footprint of two tires 34 of an electric vehicle 10 when parked on the tires positioning sensors 40 of the TRCS 20 at the perfect approach angle is illustrated. In such a configuration, the front or rear tires of the electric vehicle are parked at the center of the tire positioning sensors such that a centerline C₁ extending perpendicular to a line or axle connecting the tires 34 is oriented substantially parallel to and coplanar with the centerline C_{P} associated with the perfect approach angle. In the non-limiting embodiment of FIG. 6, the footprint of two tires 34 parked on the at least one tire positioning sensor 40 when the electric vehicle 10 is arranged at an imperfect approach angle is illustrated. As shown, each tire 34, and therefore the resulting centerline C₂ extending perpendicular to a line or axle connecting the tires is arranged at a non-parallel angle relative to the centerline C_{P} associated with the perfect approach angle. FIG. 7 is a detailed view of the angular offset between centerline C_{P} associated with the perfect approach angel and the centerline C₂ defined by two tires 34 when arranged at an imperfect approach angle as shown in FIG. 6. As can be seen, the offset of the receiving induction coil 16 in the X-direction relative to the position associated with the ideal approach angle will increase at various positions of the receiving induction coil 16 relative to the tires 34 of the electric vehicle 10, illustrated at 101 and 102.

With reference now to FIG. 8, a method 200 of using a TRCS 20 is illustrated. In operation, as shown in block 202, an available TRCS 20 is identified, and an electric vehicle 10 is driven towards the TRCS 20. In an embodiment, the TRCS 20 may include an indicator (not shown), such as a light for example, arranged at a location easily visible or audible by a driver of the vehicle. For example, the indicator may include a light positioned behind the at least one tire positioning sensor relative to a direction of travel. Upon recognizing that the tires 34 of the electric vehicle 10 are positioned on the at least one tire positioning sensor 40, as shown in block 204, the indicator may transform from a first condition or state to a second condition or state to indicate to the when driver to stop the electric vehicle 10.

In block 206, once properly positioned on the one or more tire positioning sensors 40, the controller 28 is configured to use the signals output from the one or more tire positioning sensors 40 to determine the position of the tires 34 relative to the tires positioning sensors 40. As shown in block 208, the controller 28 may then prompt the electric vehicle 10 for vehicle-specific information, and in block 210, the vehicle-specific information regarding the configuration (i.e., year, make model, etc.) of the electric vehicle is received by the controller 28. Based on the received vehicle-specific information, in block 212 the controller 28 may retrieve, such as from a look-up table or other database for example, the dimensional information of the electric vehicle 10, and including the position of the receiving induction coil 16 relative to the one or more tires 34. The RFID tag in block 208 may optionally be queried by being placed in a location farther away from the tire positioning sensors 40 which can prepare certain controller 28 functions and/or presets in advance of a vehicle's arrival to the tire positioning sensors 40.

Using the position of the receiving induction coil 16 relative to the one or more tires 34 and the position of the tires 34 relative to the tire positioning sensors 40, the controller 28 can automatically determine an exact position of the receiving induction coil 16, as shown in block 214. In response to identifying the exact position of the receiving induction coil 16 of the electric vehicle 10, in block 216 the controller 28 will communicate this position information and/or one or more movement commands to the positioning system 32 to move the charging induction coil 26 to an optimal charging position relative to the receiving induction coil 16. As previously described, the requirement movement of the charging induction coil 26 performed by the positioning system may include adjusting the position of the charging induction coil 26 in an X-direction, a Y-direction, and in some embodiments, in a Z-direction.

A TRCS 20 as illustrated and described herein is able to recognize the exact position of the electric vehicle, including the skew thereof, before beginning a charging operation, and before beginning to reposition the charging induction coil 26.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A system for charging a vehicle having a receiving coil and an electric power source electrically coupled to the receiving coil, the system comprising:
a charging coil;
an elongated pressure sensor mat formed as a continuous structure configured to simultaneously receive and sense positions of two tires of the vehicle; and
a controller operably coupled to the elongated pressure sensor and the charging coil, the controller being operable to:
determine a location of the receiving coil; and
adjust a position of the charging coil in response to the location of the receiving coil to maximize a charge rate of the electric power source.

2. The system of claim 1, wherein the controller is operable to receive vehicle-specific information from the vehicle.

3. The system of claim 2, wherein the vehicle-specific information includes a year, make, and model of the vehicle.

4. The system of claim 2, wherein the vehicle-specific information includes a vehicle identification number.

5. The system of claim 2, wherein the controller is operable to identify at least one physical dimension of the vehicle in response to the vehicle-specific information.

6. The system of claim 1, wherein the elongated pressure sensor mat is operable to sense a location of a footprint of a tire of the vehicle.

7. The system of claim 1, wherein the elongated pressure sensor mat includes an array of mechanical action switches.

8. (canceled)

9. The system of claim 1,
wherein the controller is operable to receive a signal indicating a position of the vehicle from the elongated pressure sensor mat, and
wherein said controller is operable to determine the location of the receiving coil in response to the signal indicating the position of the vehicle.

10. The system of claim 1, wherein the location of the receiving coil determined by the controller includes a distance of the receiving coil above a ground level.

11. The system of claim 1, further comprising a positioning system operably coupled to the charging coil and to the controller.

12. The system of claim 11, wherein the controller is operable to communicate at least one of the location of the receiving coil and a movement command to the positioning system.

13. A system for charging a vehicle having a receiving coil and an electric power source electrically coupled to the receiving coil, the system comprising:
a charging coil;
a positioning system operably coupled to the charging coil;
an elongated pressure sensor mat formed as a continuous structure configured to simultaneously receive and sense positions of two tires of the vehicle; and
a controller operably coupled to the elongated pressure sensor mat, the charging coil, and the positioning system, the controller being operable to:
receive a signal indicating a position of a tire of the vehicle relative to the elongated pressure sensor mat;
receive vehicle-specific information;
identify an exact location of the receiving coil based on the position of the tire of the vehicle relative to the elongated pressure sensor mat and the vehicle-specific information; and
communicate the exact location of the receiving coil to the positioning system.

14. The system of claim 13, wherein being operable to receive the signal indicating the position of the tire further comprises being operable to receive the signal indicating the position of a first tire and a second tire of the vehicle relative to the elongated pressure sensor mat.

15. The system of claim 13, wherein the controller further comprises an RFID reader operable to receive the vehicle-specific information from the vehicle.

16. The system of claim 13, wherein the controller is operable to identify at least one physical dimension of the vehicle using the vehicle-specific information.

17. The system of claim 16, wherein the controller is operable to identify the position of the receiving coil relative to the tire using the at least one physical dimension of the vehicle.

18. The system of claim 13, wherein the vehicle-specific information includes a year, make, and model of the vehicle.

19. The system of claim 13, wherein the vehicle-specific information includes a vehicle identification number.

20. The system of claim 1, wherein a weatherproof layer is formed on the elongated pressures sensor mat.

21. The system of claim 13, wherein a weatherproof layer is formed on the elongated pressures sensor mat.
